(19) United States
(12) Patent Application Publication
(10) Pub. No.: US 2005/0279776 A1
(43) Pub. Date: Dec. 22, 2005

(54) Fluid dispenser

(75) Inventors: Laurent Decottignies, Cergy (FR); Alain Behar, Suresne (FR)

Correspondence Address: SUGHRUE MION, PLLC, 2100 PENNSYLVANIA AVENUE, N.W., SUITE 800, WASHINGTON, DC, 20037, US

(73) Assignee: AIRLESSYSTEMS

(21) Appl. No.: 11/004,911

(22) Filed: Dec. 7, 2004

(30) Foreign Application Priority Data
Dec. 12, 2003 (FR) FR-03/14636

(51) Int. Cl. B67D 5/42; G01F 11/00

(52) U.S. Cl. 222/386

(57) ABSTRACT

A fluid dispenser comprising a fluid reservoir of variable working volume, at least one deformable wall defining an inside surface, and a dispenser orifice through which the fluid is dispensed while the working volume of the reservoir is being reduced by deforming the deformable wall, the dispenser further comprising a piston element that is in leaktight sliding contact with the inside surface of the deformable wall, said piston element comprising an upstream face that is not in contact with the fluid, and a downstream face that is in contact with the fluid and that forms a displaceable wall of the reservoir, said upstream face being separated from said downstream face by a zone that is in leaktight contact with the inside surface.

The present invention relates to a fluid dispenser comprising: a fluid reservoir of variable working volume comprising at least one deformable wall defining an inside surface; and a dispenser orifice through which the fluid is dispensed while the working volume of the reservoir is being reduced by deforming the wall. The term “fluid” refers to any substance in liquid, paste, or even powder form, that is suitable for being applied on an application surface, or for being dispensed into the atmosphere. This type of dispenser assembly is used, in particular, in the fields of pharmacy, cosmetics, or even perfumery.

### BACKGROUND OF THE INVENTION

In the prior art, dispensers having flexible walls that push the fluid towards a dispenser orifice when they are deformed are known. Amongst the most common are tubes having compressible or squeezable walls, more commonly referred to as “squeeze bottles”. That type of dispenser ejects fluid by compressing the wall, and generally presents, at a dispenser head, an outlet check-valve for preventing the fluid from coming into contact with the air, thereby preventing any contamination or deterioration of the fluid contained in the tube. In general, those types of dispenser include a fluid reservoir having flexible walls that are capable of being squeezed or compressed so as to raise pressure within the reservoir, thereby displacing the outlet valve at the dispenser head from a closed position to an open position that is compatible with expelling the fluid contained in the reservoir.

Nevertheless, that type of dispenser presents several drawbacks. In that type of dispenser, the dispensing of fluid can be affected by the intensity of the compression exerted on the wall of the reservoir, by the type of fluid contained in the reservoir, and also by the level at which compression is applied relative to the remaining quantity of fluid contained in the reservoir. Thus, one of the most common problems associated with the use of such a dispenser is that compression that is too great, or that is exerted at an inappropriate location on the reservoir can, for example, cause an incorrect amount of fluid to be expelled, or can, for example, cause a large amount of fluid to be forced towards the bottom of the reservoir, thereby causing only a small amount of fluid to be expelled. That type of dispenser having deformable walls uses a reservoir having a volume that tends to return to an initial state in which the wall of the reservoir is not stressed. Consequently, as the dispenser empties, the location at which compression must be applied, and the intensity of said compression, for ensuring that the desired dose of fluid is correctly expelled through the dispenser orifice are likely to vary. The problem is even more critical when the fluid has a pasty or viscous nature. Under such circumstances, the fluid is more difficult to expel, resulting in the need to press on the walls of the dispenser several times in succession to cause the fluid to rise towards the dispenser head in sufficient quantity. Sometimes, it is also necessary to turn the tube upsidedown, so as to make it easier to dislodge the fluid from the bottom and from the walls, and thus direct the fluid towards the dispenser head.

Those actuating and dispensing problems are common to all squeeze dispensers, particularly when they do not have a check-valve. However, even with such a valve, actuation, and in particular the metering out of the fluid being dispensed, remain problematic.

### OBJECTS AND SUMMARY OF THE INVENTION

The present invention therefore proposes resolving the above-mentioned problems by developing a fluid dispenser including a reservoir having deformable walls, and having a volume that is reduced each time the wall is deformed, thereby making fluid dispensing safer and more uniform in terms of the quantities delivered for equivalent squeezing. The present invention also seeks to prevent repeated actuations, or having to turn the dispenser upsidedown or shake it in some other way so that the fluid flows in sufficient quantity through the dispenser orifice. The present invention also seeks to simplify the expulsion of liquid at the dispenser head.

In order to achieve these objects, the present invention proposes a fluid dispenser comprising: a fluid reservoir of variable working volume comprising at least one deformable wall defining an inside surface; and a dispenser orifice through which the fluid is dispensed while the working volume of the reservoir is being reduced by deforming the deformable wall, the dispenser further comprising a piston element that is in leaktight sliding contact with the inside surface of the deformable wall, said piston element comprising an upstream face that is not in contact with the fluid, and a downstream face that is in contact with the fluid and that forms a displaceable wall of the reservoir, said upstream face being separated from said downstream face by a zone that is in leaktight contact with the inside surface. The dispenser of the present invention therefore differs greatly from prior-art dispensers in that it presents a piston element that slides in leaktight manner inside the reservoir, thereby enabling the fluid to remain permanently in direct contact with the dispenser head and the outlet orifice. An original aspect of the dispenser resides in combining a reservoir having deformable walls with a piston element that slides in leaktight contact with the wall of the reservoir. In general, pistons of the follower or scraper type are associated with reservoirs having rigid walls, and having pumps or valves mounted thereon.

According to another characteristic of the invention, the deformable wall defines an actuator zone situated upstream from the upstream face, said actuator zone being capable of being deformed so that the inside surface urges the piston element in such a direction that the working volume of the reservoir is reduced. Using the thumb and the index finger, for example, the user presses on the actuator zone in such a manner as to squeeze it. The actuator zone is situated behind the piston element, i.e. at a location on the deformable wall which is not in contact with the fluid, but which could have been beforehand, when the piston element was positioned further upstream.

The deformable wall advantageously defines an actuator zone situated downstream from the downstream face. In this case, the actuator zone is situated at a location on the deformable wall where the inside surface is in contact with the fluid. In other words, the actuator zone is situated between the piston element and the dispenser orifice.

According to another advantageous characteristic of the invention, the deformable wall defines a substantially cylindrical slide barrel in which the piston element slides in leaktight manner, said barrel defining the actuator zone and at least a portion of the inside surface. The inside surface advantageously includes grooves over at least a portion of the height of the barrel, said grooves being capable of co-operating with at least one sealing bead situated on said piston element. In a variant, the deformable wall includes grooves over at least a portion of the height of the barrel, said grooves being capable of co-operating with at least one sealing bead situated on said piston element. The barrel is advantageously situated between a substantially rigid bottom end and a top end defining a dispenser head provided with the dispenser orifice.

According to another aspect of the invention, the piston element is a ball, or the piston element includes a sleeve that is in leaktight sliding contact in the reservoir. In this second embodiment, the downstream face of the piston element includes a plunger that is in contact with the fluid, the reservoir forming a dispenser head provided with the dispenser orifice, the plunger penetrating into the head so as to reduce the dead volume of the reservoir. This characteristic is particularly advantageous, enabling the dead volume of the reservoir to be minimized, thereby enabling the reservoir to be emptied completely, preventing any fluid from being wasted.

According to another advantageous characteristic of the invention, the piston element is provided with one-way displacement means for displacement in such a direction that the working volume of the reservoir is reduced, said displacement means advantageously being made in the form of a barb or of a ratchet. This characteristic is particularly advantageous, providing solid anchoring of the piston element in the reservoir. The one-way displacement means are particularly advantageous when the actuator zone is situated between the piston element and the dispenser orifice: the piston element remains in place during squeezing, and is displaced by suction as soon as the dispenser orifice is closed.

The piston element advantageously comprises a leaktight sliding ring and a retaining ring connected together by actuator means that are actuatable through the deformable wall. The retaining ring advantageously includes a bottom edge that is capable of biting into the inside surface of the barrel. The actuator means advantageously include flexible deformable tabs connecting the sliding ring to the retaining ring. The actuator means are advantageously capable of bringing the retaining ring towards the sliding ring after ceasing to squeeze the deformable wall. The upstream face of the piston element is advantageously bullet-shaped. The deformable wall advantageously defines an actuator zone between the sliding ring and the retaining ring, substantially level with the actuator means.

According to another aspect of the invention, the dispenser orifice is a self-sealing slot that is capable of becoming closed in sealed manner in the absence of pressure in the reservoir. This characteristic is advantageous, avoiding the use of a check valve at the dispenser head for preventing the fluid from coming into contact with the air, the self-sealing slot sufficing to close the dispenser orifice in sealed manner in the absence of pressure being applied on the reservoir.

According to another advantageous characteristic of the invention, the dispenser includes a bottom end situated upstream from the upstream face of the piston element, said bottom end being open so as to enable the piston element to be inserted in the reservoir.

According to another aspect of the invention, the dispenser includes a dispenser head forming the dispenser orifice, said head being provided with a removable cap designed to close the dispenser orifice.

The present invention also proposes two filling methods for filling such a dispenser.

The first method comprises the following steps:

a) before inserting the piston element, inserting the fluid into the reservoir;

b) in a chamber in which a vacuum exists, inserting the piston element into the reservoir; and

c) returning the dispenser to atmospheric pressure.

The second filling method comprises the following steps:

a) before inserting the piston element, inserting the fluid into the reservoir; and

b) force-fitting the piston element into the reservoir, trapped air being forced out between the piston element and the inside surface.

Advantageously, while the dispenser of the invention is being filled, the dispenser orifice is closed, and the piston element is brought into contact with the fluid. In the event of vacuum packaging being used, the piston element is automatically brought into contact with the fluid when the dispenser is returned to atmospheric pressure.

### BRIEF DESCRIPTION OF THE DRAWINGS

The invention is described more fully below with reference to the accompanying drawings which show various embodiments of a dispenser of the invention by way of non-limiting example.

In the figures:

FIGS. 1a to 1d are sequential diagrams showing how the fluid dispenser constituting a first embodiment of the invention operates;

FIGS. 2a to 2g are sequential diagrams showing how the fluid dispenser constituting a second embodiment of the invention operates;

FIGS. 3a to 3e are sequential diagrams showing another way in which the fluid dispenser constituting the second embodiment of the invention operates;

FIG. 4 is a larger-scale view of a detail of the piston element of the second embodiment;

FIG. 5 shows a modification applied to the dispenser;

FIG. 6 shows a variant embodiment of the piston element;

FIG. 7 shows another variant embodiment of the piston element;

FIG. 8 is a larger-scale view of a variant embodiment of the dispenser of the invention;

FIG. 9 is a larger-scale view of another variant embodiment of the dispenser of the invention; and

FIG. 10 is a larger-scale view of another variant embodiment of the dispenser of the invention.

### MORE DETAILED DESCRIPTION

In the various embodiments of the invention, the dispenser device comprises two component elements, namely a dispenser 1, and a piston element 2; 2′; 2″; or 2′″. The dispenser 1 can be identical in all embodiments. The dispenser 1 comprises a body in the form of: a rigid bottom end defining a reinforcing sleeve 14; a barrel 11; and a top end defining a dispenser head 15. The dispenser 1 is advantageously made as one piece of a plastics material such as low-density polyethylene, for example.

The barrel 11 is generally cylindrical, and in a preferred embodiment of the invention, it is approximately a length of a circular cylinder. However, other shapes can be envisaged, such as an oval, an ellipse, an oblong, etc. Thus, the term “cylindrical” should be considered in the broadest possible sense. It is even possible to envisage the barrel being non-cylindrical, e.g. frustoconical. The barrel 11 comprises a deformable wall 13 presenting both an outside surface defining the outline of the barrel, and an inside surface 12. The deformable wall 13 advantageously presents shape memory which tends to return it to its initial cylindrical position. The wall defining the cylindrical barrel is deformable over all or part of the height of the barrel. The wall thus defines actuator zones 132 that can be deformed by squeezing. It is advantageous for the inside surface 12 of the barrel to be at least substantially cylindrical, while the outside surface can be of any shape or profile.

The sleeve 14 situated at the bottom end of the barrel comprises substantially rigid walls. The walls are substantially thicker and more rigid than the deformable wall 13 of the barrel. The inside surface 12 of the barrel is advantageously an extension of the inside of the sleeve. The rigid sleeve 14 keeps the bottom end of the barrel 11 in a cylindrical shape, and contributes to the shape memory of the barrel. The sleeve 14 defines an opening 141 giving access to the inside of the barrel 11. However, it is possible to envisage closing the opening 141.

At its opposite top end, the barrel 11 is connected to a dispenser head 15 by means of an inwardly-directed shoulder 115. The head 15 comprises a dome 17 that is advantageously provided with a self-sealing slot serving as a dispenser orifice 16. The dome 17 can be replaced by any shape that is appropriate to the present embodiment. The wall forming the dome can be long or short. In addition, the orifice 16 is not necessarily self-sealing, and its position on the dispenser head 15 can vary, with it even being possible to locate it laterally, for example. The orifice can be formed by an outlet valve that is added on or made by dual injection. In a preferred embodiment of the invention, the dispenser head 15 includes fastener means 153 situated above the shoulder 115, and enabling a cap 3 to be fastened in removable manner. The fastener means 153 can be in the form of an outside thread or a bead, for example.

The cap 3 covering the dispenser head 15 presents a top end 36 that overlies the dome of the head. The cap also has a bottom end 35 that is advantageously reinforced, presenting walls that are substantially thicker. The cap is optional. The bottom end 35 advantageously possesses fastener means 351 that are complementary to the fastener means 153 situated on the dispenser head 15. The fastener means 351 are in the form of a complementary inside thread or a groove designed to co-operate with the bead so as to establish snap-fastening. However, any technique designed to fasten the cap 3 on the dispenser head 15 can be used, e.g. a snap-fastener system. The cap mounted on the dispenser head advantageously comes into abutment against the shoulder 115 of the barrel. The cap can contribute to maintaining the self-sealing slot 16 in the closed position, so as to prevent any accidental dispensing. In a preferred embodiment of the invention, the top end 36 presents a shape that is advantageously complementary to the shape of the dispenser head 15, thereby matching the shape of the dome 17.

The second component element of the present invention is the piston element 2; 2′; 2″; or 2′″. The piston element is advantageously made of hard material, e.g. from polypropylene, or from stainless steel. In this case, the piston element is presented in two particular forms that are advantageous. Firstly, the piston element 2 is in the form of a ball, constituting a first embodiment. Secondly, the piston element 2′; 2″; 2′″ is in the form of a cylindrical sleeve 23 surmounted by a plunger 24, constituting other embodiments.

The ball 2 presents a shape that is advantageously substantially spherical, but it could also present a shape that is oval, ellipsoidal, oblong, . . . . In the invention, the ball is inserted into the body through the opening 141 formed by the sleeve 14. Preferably, the ball is initially engaged as far as the barrel. Thus, the ball, the barrel, and the dispenser head together form a fluid reservoir 10 which is advantageously designed to be filled completely with fluid. The ball 2 presents a downstream face 22 that is in contact with the fluid, an upstream face 21 that is in contact with the air, and a zone 20 that is in leaktight contact with the inside surface 12 of the barrel. The width of the contact zone depends on the shape of the ball. The reservoir 10 is defined by the downstream face 22, the inside surface 12, and the dome 17 formed at the top end of the dispenser head. The downstream face 22 defines a moving wall of the reservoir 10: the ball is mounted in leaktight sliding contact with the barrel, so that the working volume of the reservoir varies with the displacement of the ball.

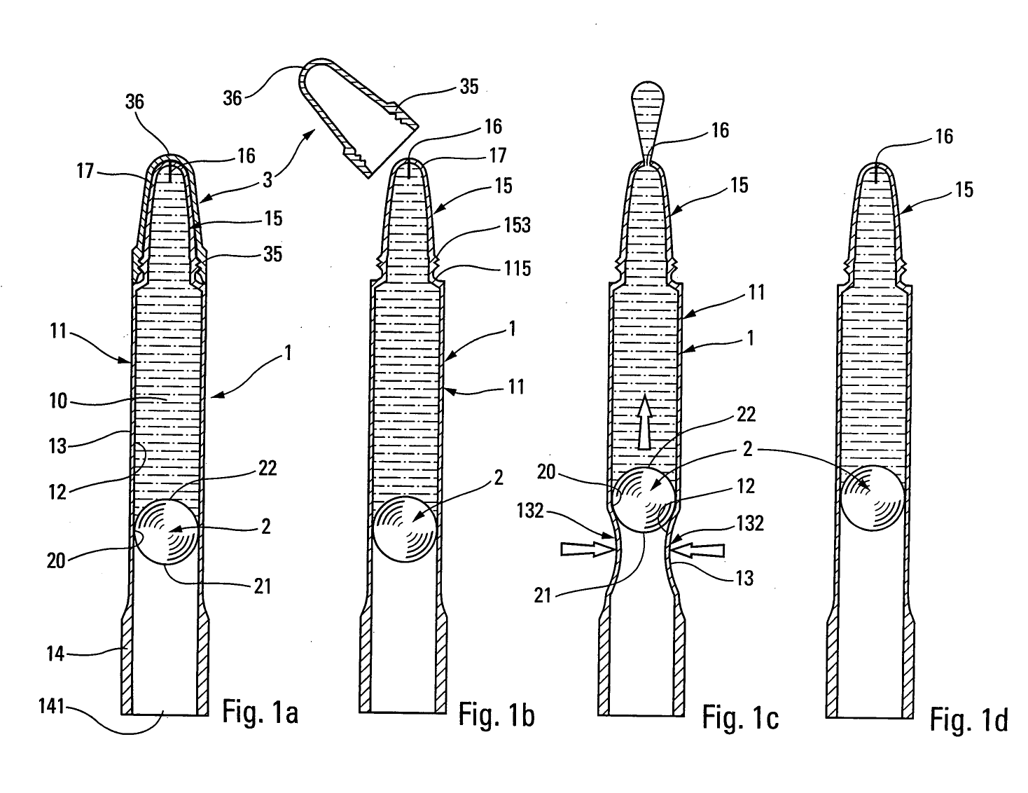

FIG. 1a shows the dispenser 1 provided with the cap 3. The dispenser presents a wall 13 that is not flattened, i.e. that is not deformed, by squeezing. After removing the cap 3 covering the dispenser head 15, as shown in FIG. 1b, the wall 13 can be deformed by squeezing. The deformation is applied upstream from the ball 2, and results in the wall 13 flattening. The deformable wall thus defines an actuator zone 132. As shown in FIG. 1c, squeezing the wall 13 in the actuator zone 132 tends to push against the upstream face 21 of the ball. The contact between the inside surface of the barrel and the upstream face of the ball thus causes the ball to slide in the barrel, while maintaining a leaktight contact zone 20 against the inside surface 12 of the barrel. The sliding of the ball thus causes fluid to be expelled through the dispenser orifice 16 which opens under the effect of the pressure. FIG. 1c also shows that the working volume of the reservoir 10 is reduced as a result of the deformable wall 13 being squeezed. The ball slides in the barrel until the actuator zone reaches a state of maximum deformation. During its leaktight sliding, the downstream face of the ball pushes the fluid towards the orifice. As soon as the deformation reaches is maximum state, the ball stops sliding, and fluid ceases to be dispensed through the orifice. The self-sealing slot closes. Relaxing the compression which generated the deformation zone has no effect either on the ball or on the fluid. The inside surface of the deformed zone is not in contact with the fluid.

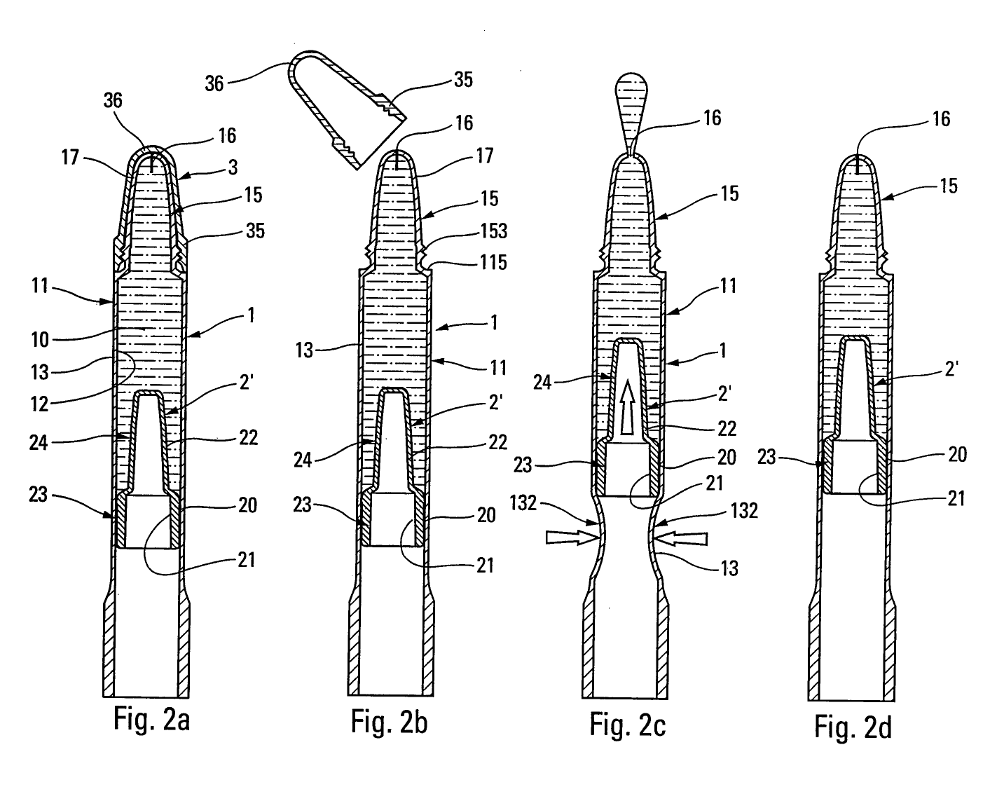

FIGS. 2a to 2d show a second embodiment of the invention in an operating sequence that is identical to the operating sequence shown in FIGS. 1a to 1d; the body is identical, but the ball 2 has been replaced by the piston element 2′. The piston element 2′ comprises a sliding sleeve 23, and a plunger 24. The cylindrical sleeve 23 also presents an outside surface which defines a zone 20 that is in leaktight contact with the inside surface 12 of the barrel. The piston element 2′ also defines a downstream face 22 formed by the outside surface of the plunger, and an upstream face 21 formed by the inside surface of the plunger and of the sleeve. As can be seen in FIG. 2c, the wall 13 of the barrel is likewise deformed by squeezing in an actuator zone 132 situated upstream from the cylindrical sleeve 23. At the actuator zone, the inside surface 12 bears against the upstream face 21 of the cylindrical sleeve, thus causing the piston element 2′ to slide along the barrel. This sliding, and a reduction in the working volume of the reservoir 10, thus leads to fluid being expelled through the dispenser orifice 16. The downstream face 22 forms a moving wall of the reservoir. Once the wall 13 has been flattened as much as possible, as shown in FIG. 2c, the piston element 2′ ceases to advance, and the fluid ceases to be expelled. Returning to the initial rest position has no effect on the piston element 2′.

As shown in FIGS. 2e to 2g, repeated squeezing of the wall 13 leads to a progressive reduction in the working volume of the reservoir 10, resulting from the piston element 2′ advancing along the barrel 11. In this embodiment of the piston element, and as shown in FIG. 2g, the plunger 24 presents a downstream face 22 that is advantageously complementary to the shape defined by the dispenser head 15. Thus, once the cylindrical sleeve 23 becomes blocked under the inwardly-directed shoulder 115, the downstream face 22 of the plunger, which is advantageously frustoconical, extends into the dispenser head 15, matching its shape. Matching the shape of the head 15 with the downstream face 22 of the plunger thus ensures that the dead volume of the reservoir 10 is minimized. This results in a maximum amount of the fluid contained in the reservoir being dispensed. It should be noted that it is possible to envisage numerous complementary shapes that make it possible to guarantee good reduction of the dead volume of the reservoir. The shapes shown for the plunger 24 and for the dispenser head are given by way of non-limiting example only.

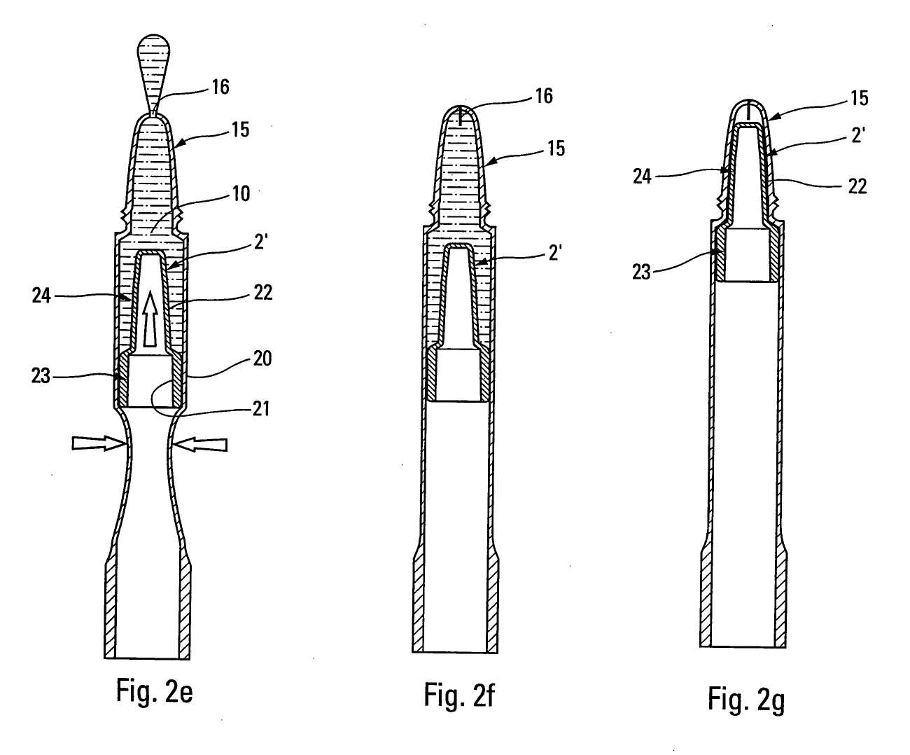

FIGS. 3a to 3e show another way of operating the present invention implementing the dispenser constituting the second embodiment. FIG. 3a shows the dispenser in its rest state provided with the cap. After removing the cap, as shown in FIG. 3b, the wall 13 of the barrel is deformed by squeezing an actuator zone 133 situated downstream from the piston element 2′, as can be seen in FIG. 3c. The squeezing initially causes fluid to be expelled through the dispenser orifice 16, while the piston element remains in position. Once the maximum compression is reached, the dispenser orifice closes, ceasing to expel fluid contained in the reservoir 10. Thus, once the dispenser orifice has closed, the wall 13 seeks to return to its initial shape, creating suction in the reservoir. The suction draws up the piston element, which then slides in leaktight manner along the inside wall 12 of the barrel. The downstream face 22 of the plunger thus remains in contact with the fluid, as shown in FIG. 3e.

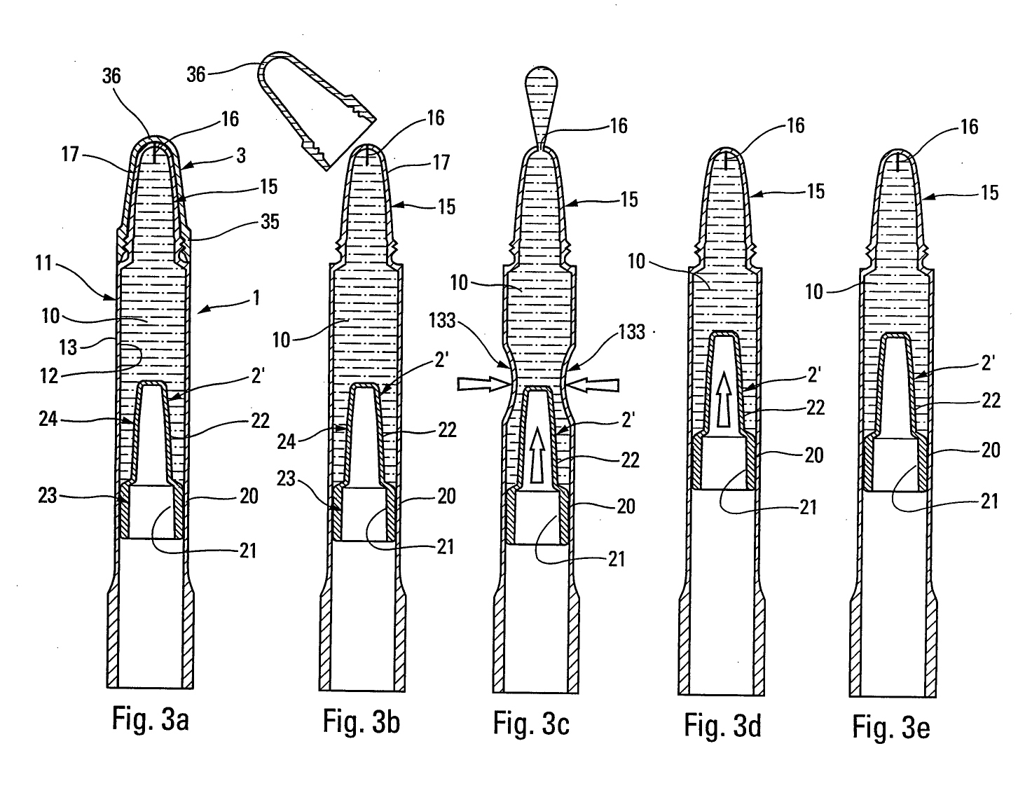

In a preferred embodiment of the invention, shown in FIG. 4, the piston 2′ can include a projecting profile in the form of a barb 231. The barb is advantageously disposed at the contact zone 20 of the sleeve. The function of the barb is to bite into the inside surface 12 of the barrel, with the purpose of forming anti-return means for the piston element 2′. Thus, during compression, downstream from the piston element 2′, the cylindrical sleeve 23 remains in its position as a result of the barb 231 being anchored in the inside surface 12. The barb 231 thus prevents any displacement of the piston element 2′ in the upstream direction. It should be noted that such a barb 231 could also be easily adapted to a ball 2.

It should be noted that the use of the dispenser in accordance with FIGS. 3a to 3e requires the force needed to open the dispenser orifice 16 is less than the friction force between the piston element and the inside wall 12 of the barrel. It is also necessary for the orifice to close in sealed manner, and for the shape memory of the deformable wall is sufficient to create suction that is capable of drawing up the piston element.

The piston element can present other particularly advantageous shapes, making it easier for the user to handle the dispenser.

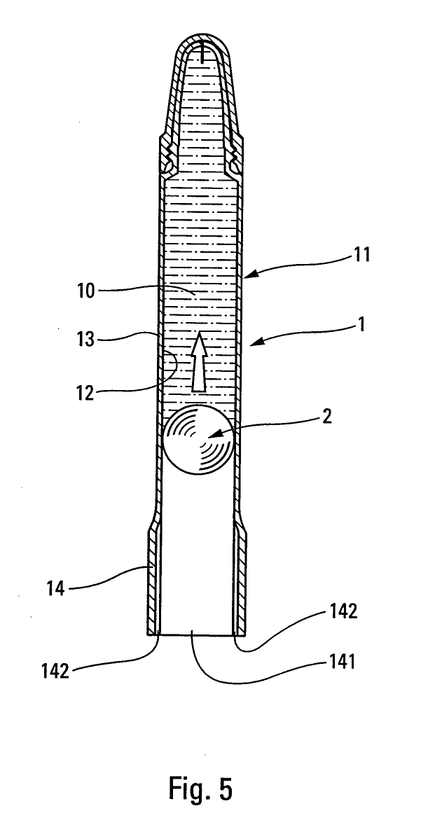

FIG. 6 presents a piston element 2″ comprising a plunger 24, and a sleeve 23. The sleeve 23 includes a zone 20 that is in leaktight contact with the inside surface 12 of the barrel 11. The piston element presents a downstream face 22 that is in contact with the fluid, and an upstream face 21 that is in contact with the air. In this embodiment, the sleeve 23 presents a bullet-shaped upstream face designed to make the dispenser comfortable to use, and to facilitate the displacement of the piston element after the deformable wall 13 of the barrel has been squeezed.

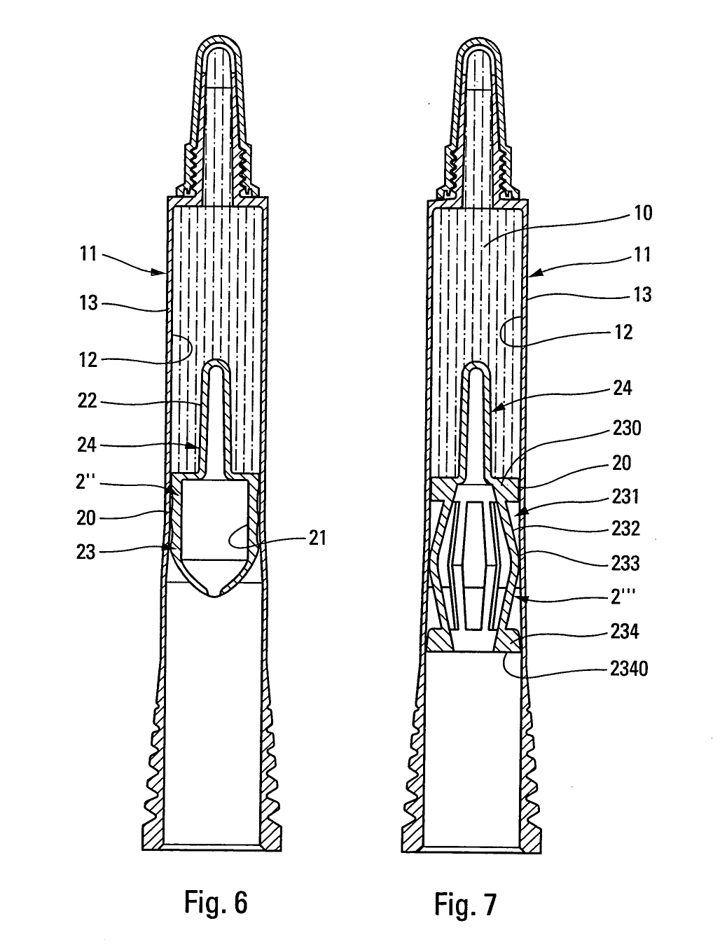

FIG. 7 presents a piston element 2′″ comprising a plunger 24, a sliding ring 230, actuator means 231, and a retaining ring 234. The sliding ring 230 forms a zone 20 that is in leaktight contact with the inside surface 12 of the barrel. The actuator means 231 extend from the sliding ring 230 to the retaining ring 234. The actuator means 231 comprise resiliently deformable tabs 232 which are hinged at bends 233 that advantageously engage the inside surface 12 of the barrel. This bent configuration corresponds to a rest position of the piston element. The tabs could also be bowed instead of being bent. The tabs thus perform a toggle function, enabling the tabs to be lengthened by elastically deforming the bends. After being deformed, the bent tabs return to their rest position.

The retaining ring 234 presents a general shape that is advantageously conical. The ring 234 includes a bottom edge 2340 that is capable of biting into the inside surface 12 of the barrel, thereby serving as anti-return means for the piston element 2′″.

Thus, in this embodiment, the fluid is dispensed by squeezing the deformable wall 13 of the barrel level with the bends of the tabs 232. Squeezing causes the tabs 232 to extend longitudinally as a result of the bends 233 being deformed. This causes the sliding ring 230 to move in the direction that reduces the working volume of the reservoir, while the retaining ring, gripping the inside surface 12 of the barrel, remains in position. Once the pressure exerted on the deformable wall 13 is relaxed, the bends 233, as a result of their shape memory, pull the retaining ring 234 towards the sliding ring. The retaining ring moves to a more downstream position in the barrel, while the sliding ring 230 remains in position. The retaining ring 234 therefore constitutes anti-return means, guaranteeing one-way progress of the sliding ring 230 in the direction that reduces the working volume of the reservoir by means of the toggle function provided by the bent tabs. Naturally, other forms of toggle can be envisaged. However, it is necessary that the actuator means cause the rings to move apart while the wall 13 is being deformed, and cause the rings to move together when the wall ceases to be deformed.

Finally, modifications can be applied to the barrel 11 of the dispenser, so as to improve the accuracy of the volume of fluid expelled after the deformable wall 13 has been squeezed.

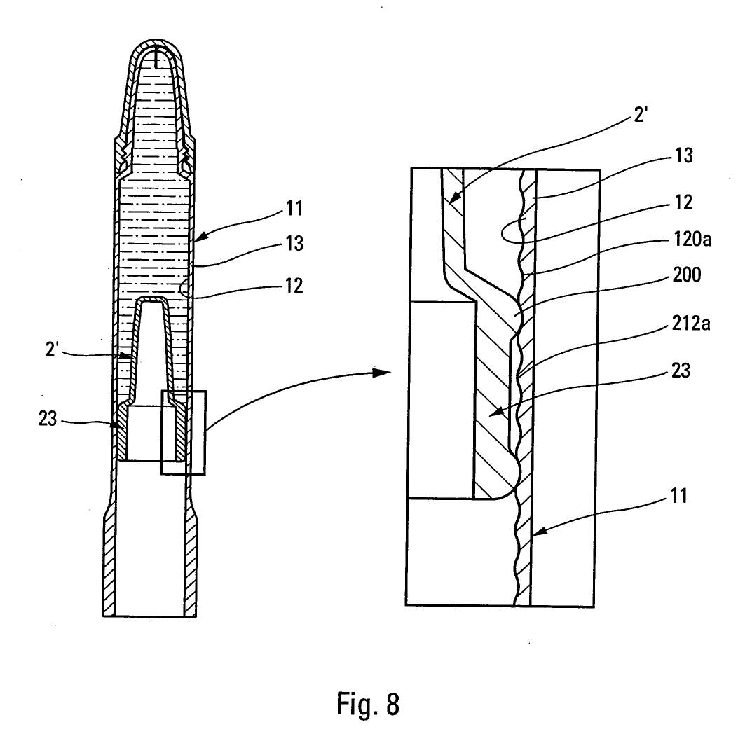

FIG. 8 presents a piston element, e.g. 2′, advantageously including, on the cylindrical sleeve 23, two sealing beads 200 co-operating with grooves 120a formed on the inside surface 12 of the barrel. The piston element can include one or more sealing beads 200 engaged in the grooves 120a. The grooves 120a form zones of the barrel having reduced wall thickness, which zones are advantageously disposed evenly over the inside surface 12 of the barrel. The grooves 120a are separated from one another by separation zones 212a. The purpose of the grooves 120a is to constrain the sealing beads 200 of the piston element to move in increments, groove by groove. Thus, the grooves 120a are similar to notches dividing the total volume of fluid into doses that are advantageously substantially identical.

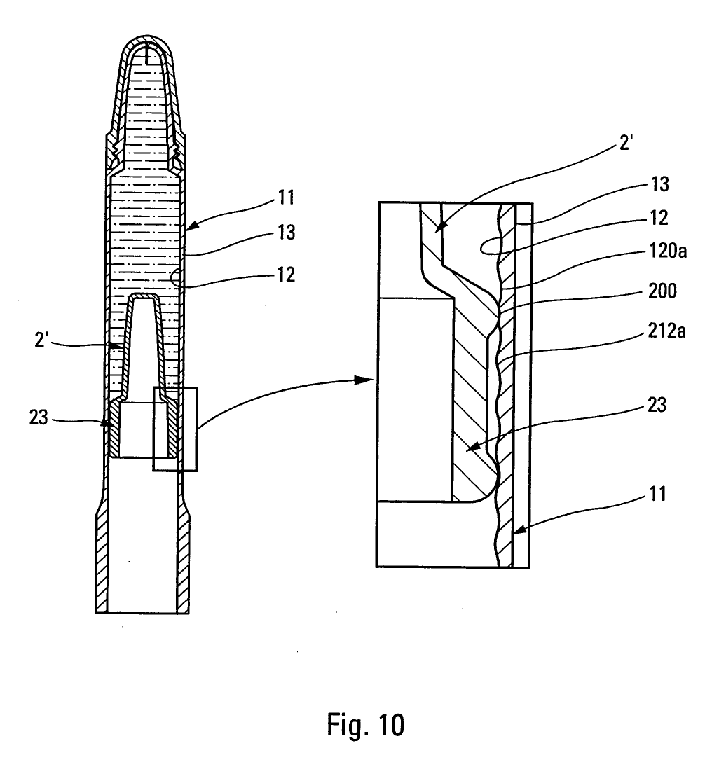

In a variant embodiment, the distance between two sealing beads can be such that, at rest, one bead is engaged in a groove 120a, while another bead is engaged on a separation zone 212a, as shown in FIG. 10. In this case, it is easier to advance the piston element along the barrel by squeezing the deformable wall 13 upstream from the piston element. The bead engaged in a groove 120a becomes positioned on a separation zone 212a, while the bead previously engaged on the separation zone 212a becomes received in a groove 120a after a squeeze. Thus, in this variant embodiment, it is easier to dispense a single dose of fluid, but the quantity of fluid expelled at each actuation of the deformable wall 13 is less than in the above-mentioned embodiments implementing the groove device. The dose is halved.

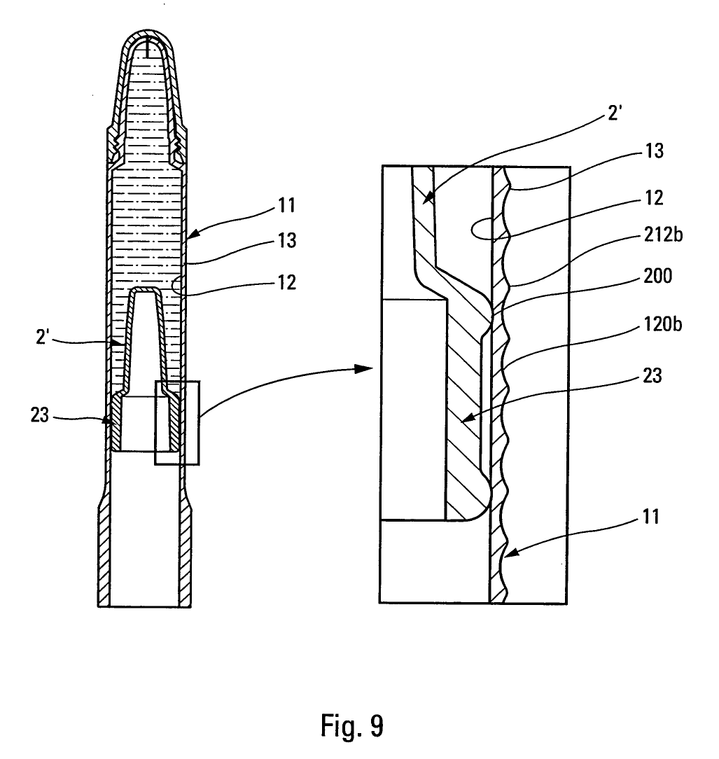

FIG. 9 presents a variant embodiment of the barrel of the dispenser in which grooves 120b are formed on the deformable wall 13. Thus, in this embodiment, said grooves 120b constitute zones of least resistance facilitating the progress of the piston element, while the separation zones 212b of the grooves 120b form hard points that make it difficult for the piston element to pass. Consequently, the alternating grooves 120b and separation zones 212b make it possible to establish reference points for metering fluid to be dispensed. It should be emphasized that the rocking progress of the piston element as shown in FIG. 10 for the grooves 120a could also be adapted to the grooves 120b.

The present invention also relates to two methods of filling a dispenser 1 of the invention.

The methods are advantageously implemented with a dispenser orifice 16 closed by a cap 3 covering the dispenser head 15.

The first method consists firstly in inserting fluid into the body 10 of a dispenser 1, and placing the full body in a vacuum chamber. A vacuum is then created and the piston element 2; 2′; 2″; 2′″ is then inserted into the body. The vacuum is then broken by returning the dispenser to atmospheric pressure. Breaking the vacuum thus enables the downstream surface 22 of the piston element 2; 2′; 2″; 2′″ to come into contact with the fluid. In a variant, it is also possible to push the piston element into contact with the fluid while in the vacuum chamber.

The second method is performed under atmospheric pressure. It begins by filling the body with fluid. The piston element 2; 2′; 2″; 2′″ is then engaged in the barrel, and the air that is trapped downstream from the piston element is thus forced out between the piston element and the inside surface 12. The forced-out air is then expelled from the body through the opening 141.

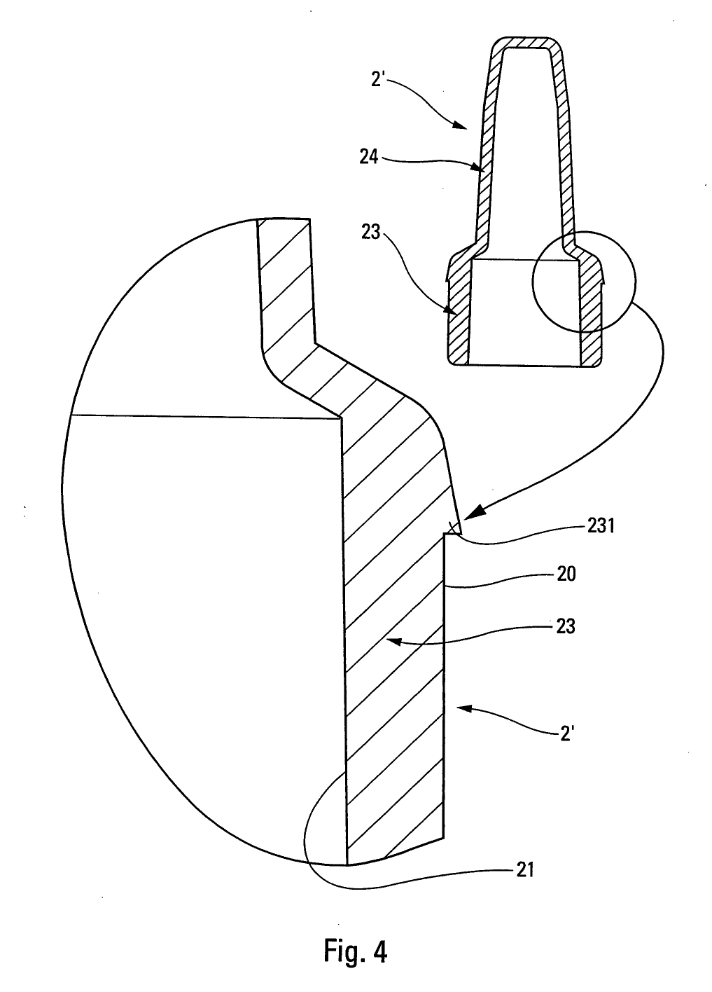

FIG. 5 shows a preferred embodiment of the invention making it easier to insert the piston element 2; 2′; 2″; 2′″ in the dispenser 1. In this embodiment, the reinforcing sleeve 14 presents vent slots 142 in its inside wall. The vent slots 142 consist of longitudinal grooves formed over the height of the sleeve 14. Thus, while the piston element 2; 2′; 2″, 2′″ is being inserted through the opening 141, the air that is present downstream from the piston element escapes through the slots, thus enabling the piston element 2, 2′, 2″, 2′″ to come into contact with the fluid more easily. Thus, the vent slots 142 enable the deformable wall 13 to be flattened to a smaller extent in order to expel the air that is trapped downstream from the piston element 2, 2′; 2″″; 2′″.

1. A fluid dispenser comprising:
a fluid reservoir of variable working volume comprising at least one deformable wall defining an inside surface; and
a dispenser orifice through which the fluid is dispensed while the working volume of the reservoir is being reduced by deforming the deformable wall,
the dispenser further comprising a piston element that is in leaktight sliding contact with the inside surface of the deformable wall, said piston element comprising an upstream face that is not in contact with the fluid, and a downstream face that is in contact with the fluid and that forms a displaceable wall of the reservoir, said upstream face being separated from said downstream face by a zone that is in leaktight contact with the inside surface.

2. A dispenser according to claim 1, in which the deformable wall defines an actuator zone situated upstream from the upstream face, said actuator zone being capable of being deformed so that the inside surface urges the piston element in such a direction that the working volume of the reservoir is reduced.

3. A dispenser according to claim 2, in which the deformable wall defines an actuator zone situated downstream from the downstream face.

4. A dispenser according to claim 3, in which the actuator zone is capable of being deformed by squeezing.

5. A dispenser according to claim 4, in which the deformable wall defines a substantially cylindrical slide barrel in which the piston element slides in leaktight manner, said barrel defining the actuator zone and at least a portion of the inside surface.

6. A dispenser according to claim 5, in which the inside surface includes grooves over at least a portion of the height of the barrel, said grooves being capable of co-operating with at least one sealing bead situated on said piston element.

7. A dispenser according to claim 5, in which the deformable wall includes grooves over at least a portion of the height of the barrel, said grooves being capable of co-operating with at least one sealing bead situated on said piston element.

8. A dispenser according to claim 5, in which the barrel is situated between a substantially rigid bottom end and a top end defining a dispenser head provided with the dispenser orifice.

9. A dispenser according to claim 1, in which the piston element is a ball.

10. A dispenser according to claim 6, in which the piston element includes a sleeve that is in leaktight sliding contact in the reservoir.

11. A dispenser according to claim 1, in which the downstream face of the piston element includes a plunger that is in contact with the fluid, the reservoir forming a dispenser head provided with the dispenser orifice, the plunger penetrating into the head so as to reduce the dead volume of the reservoir.

12. A dispenser according to claim 1, in which the piston element is provided with one-way displacement means for displacement in such a direction that the working volume of the reservoir is reduced, said displacement means advantageously being made in the form of a barb or of a ratchet.

13. A dispenser according to claim 5, in which the piston element comprises a leaktight sliding ring and a retaining ring connected together by actuator means that are actuatable through the deformable wall.

14. A dispenser according to claim 13, in which the retaining ring includes a bottom edge that is capable of biting into the inside surface of the barrel.

15. A dispenser according to claim 13, in which the actuator means include flexible deformable tabs connecting the sliding ring to the retaining ring.

16. A dispenser according to claim 13, in which the actuator means are capable of bringing the retaining ring towards the sliding ring after ceasing to squeeze the deformable wall.

17. A dispenser according to claim 1, in which the upstream face of the piston element is bullet-shaped.

18. A dispenser according to claim 13, in which the deformable wall defines an actuator zone between the sliding ring and the retaining ring, substantially level with the actuator means.

19. A dispenser according to claim 1, in which the dispenser orifice is a self-sealing slot that is capable of becoming closed in sealed manner in the absence of pressure in the reservoir.

20. A dispenser according to claim 1, including a bottom end situated upstream from the upstream face of the piston element, said bottom end being open so as to enable the piston element to be inserted in the reservoir.

21. A dispenser according to claim 1, including a dispenser head forming the dispenser orifice, said head being provided with a removable cap designed to close the dispenser orifice.

22. A filling method for filling a dispenser according to claim 1, the method comprising the following steps:
before inserting the piston element, inserting the fluid into the reservoir;
in a chamber in which a vacuum exists, inserting the piston element into the reservoir; and
returning the dispenser to atmospheric pressure.

23. A filling method for filling a dispenser according to claim 1, the method comprising the following steps:
before inserting the piston element, inserting the fluid into the reservoir; and
inserting the piston element into the reservoir, trapped air being forced out between the piston element and the inside surface.

24. A dispenser filling method according to claim 22, in which the dispenser orifice is closed.

25. A dispenser filling method according to claim 22, in which the piston element is brought into contact with the fluid.
